(19) United States
(12) Patent Application Publication
(10) Pub. No.: US 2024/0104514 A1
(43) Pub. Date: Mar. 28, 2024

(54) Smart Office Account Sync Using Hub Camera or Microphone

(71) Applicant: LENOVO (SINGAPORE) PTE. LTD., Singapore (SG)

(72) Inventors: Mark Christopher Heidenfeldt, Apex, NC (US); Sandy Collins, Durham, NC (US); Mark K. Summerville, Apex, NC (US)

(21) Appl. No.: 17/950,780

(22) Filed: Sep. 22, 2022

(51) Int. Cl. G06Q 10/10; G06F 21/32; G06Q 10/02

(52) U.S. Cl. CPC G06Q 10/1095; G06F 21/32; G06Q 10/02

(57) ABSTRACT

An approach is provided that detects a presence of a user in a physical room and then identifies the detected user. An on-the-fly reservation request is received and the system determines that the physical room is available. One or more reservation attributes and one or more invitees are received and messages are then sent to the invitees. The messages include physical room identifier information. The user then joins a meeting in the physical room with a set of meeting attributes that include the physical room identifiers. The meeting attributes are accessible from an information handling system that is utilized by the identified user.

### BACKGROUND

A meeting room reservation system allows users to reserve a conference room. Traditional reservation systems use the conference room as the “hub” with users joining the conference room hub. In addition, if a meeting is canceled and no one cancels use of the conference room, it can be difficult for a different group to reserve the room. This can also be an issue if a meeting ends early and other users may wish to use the room, however the room is still reserved by the original meeting group.

### BRIEF SUMMARY

An approach is provided that detects a presence of a user in a physical room and then identifies the detected user. An on-the-fly reservation request is received and the system determines that the physical room is available. One or more reservation attributes and one or more invitees are received and messages are then sent to the invitees. The messages include physical room identifier information. The user then joins a meeting in the physical room with a set of meeting attributes that include the physical room identifiers. The meeting attributes are accessible from an information handling system that is utilized by the identified user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 depicts a diagram of components utilized in a smart office system that syncs a user to a physical meeting room using a hub camera or microphone;

FIG. 4 depicts the flow from the perspective of a user device that displays a user calendar meeting entry with the meeting room data being added on-the-fly;

FIG. 5 depicts steps performed by a meeting room manager;

FIG. 6 depicts steps performed by a process that reserves a physical room to a user currently present in the room on-the-fly;

FIG. 7 depicts steps performed by a physical conference room policy manager process; and

FIG. 8 depicts steps performed by a process that detects the end of a meeting taking place in a physical room.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

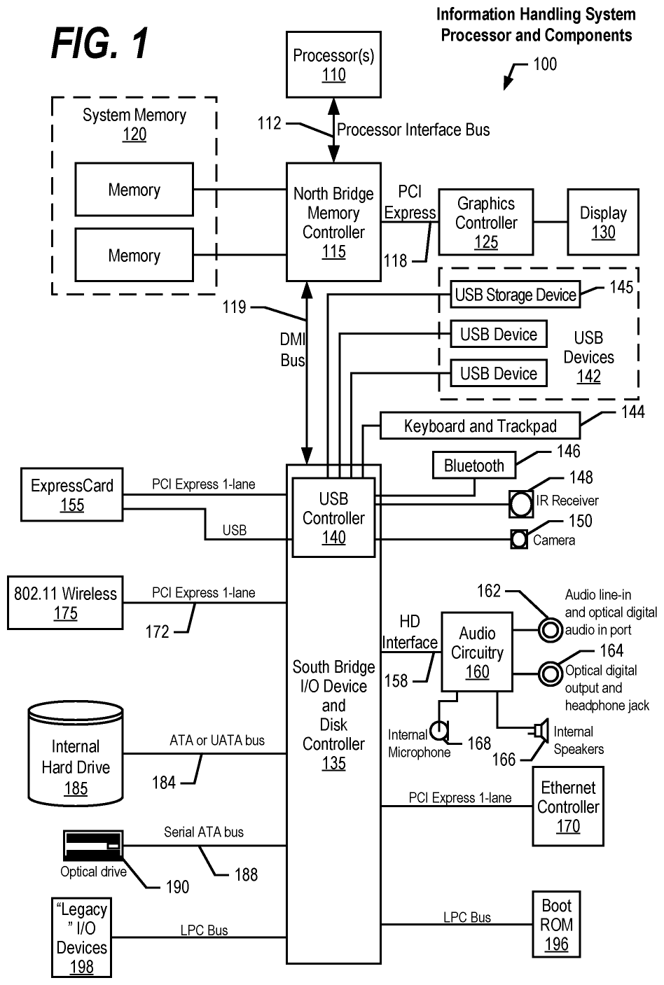

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wirelessly communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

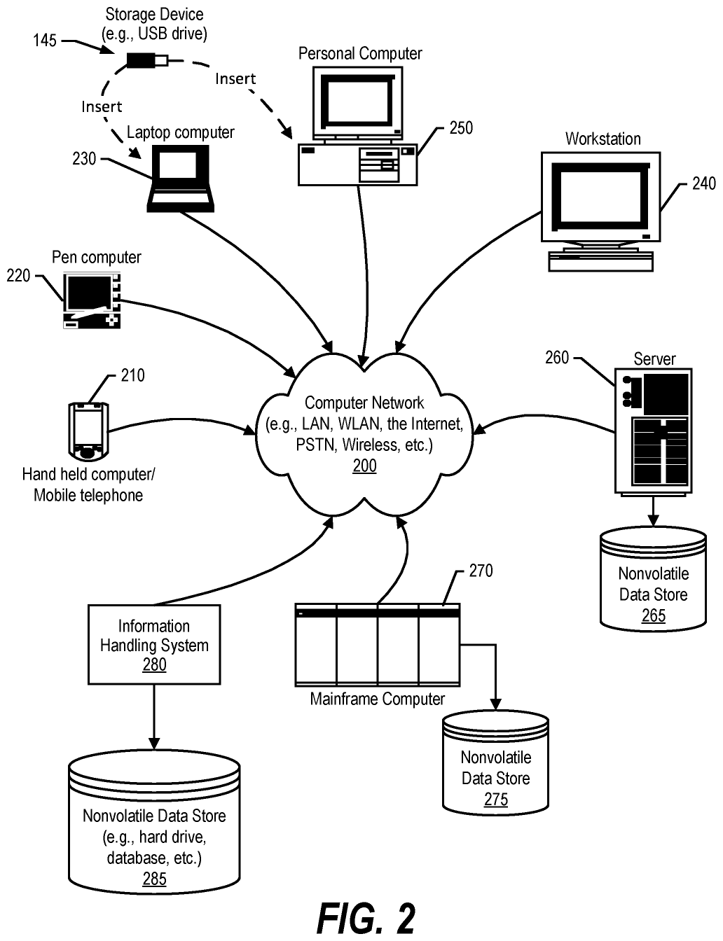

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

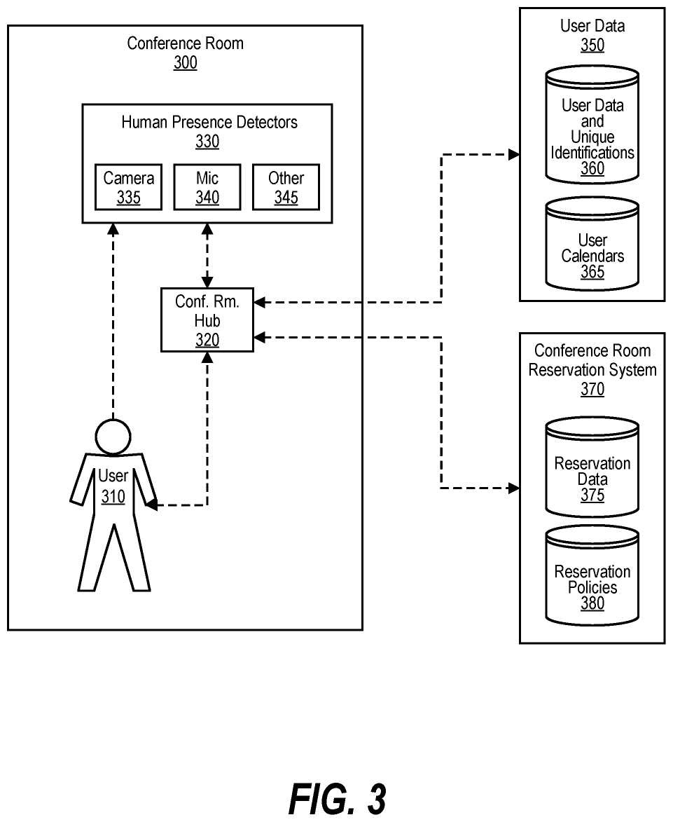

FIG. 3 depicts a diagram of components utilized in a smart office system that syncs a user to a physical meeting room using a hub camera or microphone. Physical room 300, such as a conference room or other meeting room, has various human presence detectors 330 that are used to detect the presence of user 310 in the physical room. In one embodiment, conference room hub 320 is connected to the human presence connectors and has interfaces to communicate with user 310. The human presence detectors can include digital camera 335, microphone 340, and other detectors 345, such as other biometric data detectors.

Conference room hub 320 has access to various data stores, such as user data stores 350 and conference room data stores 370. User data stores include user data and unique identification data 360, such as digitized facial images of users' faces and voice samples of users' spoken voices. User data also include online user calendars 365 where, for example, a user can set up a meeting with the meeting data including the various invitees to the meeting.

Conference room reservation room data 370 includes reservation data 375, such as which user or users have reserved the physical room at various dates and times. In addition, the conference room data includes reservation policies 380 that indicate various policies pertaining to reserving the conference room. For example, a policy can be that the conference room becomes “available” if the reservation holder does not appear in the conference room within five minutes of the scheduled start time with the available room being able to be reserved “on-the-fly” by another user that physically enters the room.

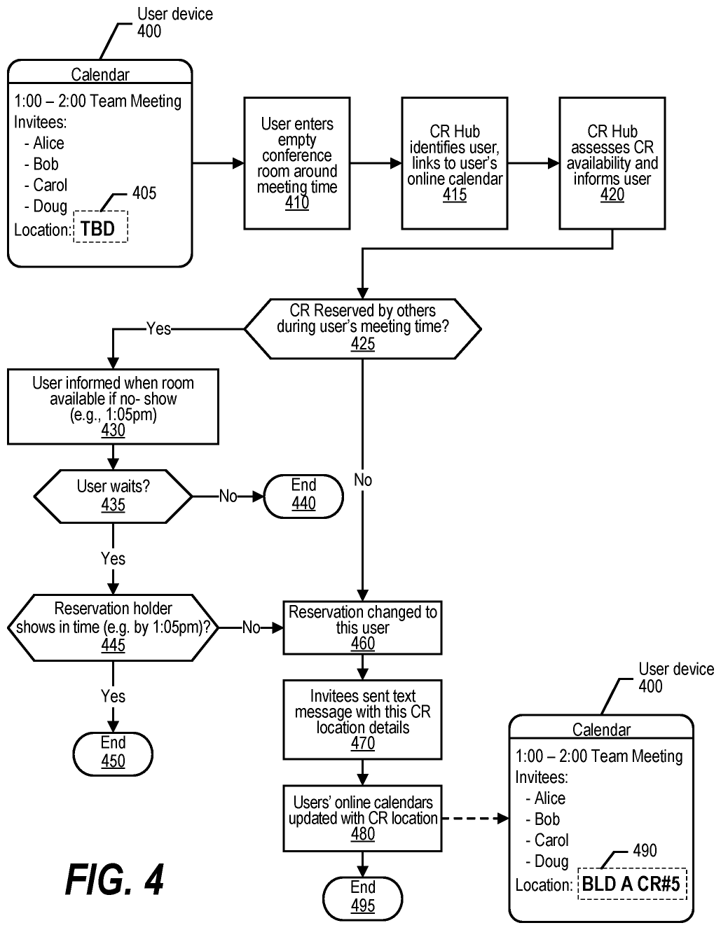

FIG. 4 depicts the flow from the perspective of a user device that displays a user calendar meeting entry with the meeting room data being added on-the-fly. At step 410, the process detects when a user enters an empty conference room around a meeting time. The user device 400 depicts a view of the user's online calendar that shows that the user is attending a meeting with various invitees with the meeting location currently being unknown (TBD 405) as no physical room has been yet reserved for the meeting.

At step 415, the conference room hub's human presence detectors identify the user and accesses the user's online calendar. At step 420, the conference room hub assesses the conference room's availability and informs user of such availability. The process determines whether the conference room is currently reserved by others during this user's meeting time (decision 425). If the conference room is reserved by others during user's meeting time, then decision 425 branches to the ‘yes’ branch to perform steps 430 through 450. On the other hand, if the conference room is not reserved by others during user's meeting time, then decision 425 branches to the ‘no’ branch to reserve the conference room for the user using steps starting at step 460.

At step 430, the user is informed as to when the room will be available if the current reservation holder does not appear in the conference room, such as five minutes after the start of the reservation time. The process detects whether the user waits in the room for possible availability (decision 435). If the user waits, then decision 435 branches to the ‘yes’ branch to perform decision 445. On the other hand, if the user does not wait, then decision 435 branches to the ‘no’ branch and processing ends at 440.

At decision 445, the process determines whether the reservation holder appears in the conference room in time (e.g. by 1:05 pm). If the reservation holder shows up in time (e.g. by 1:05 pm), then decision 445 branches to the ‘yes’ branch and processing ends at 450 with the user unable to reserve the room as others have already reserved it. On the other hand, if the reservation holder does not appear in the conference room in the time allowed (per policy), then decision 445 branches to the ‘no’ branch so that the room reservation can be changed to the user.

At step 460, the reservation of the physical room is changed to this user. At step 470, the invitees of the meeting appearing on the user's calendar for the current date and time are sent text message with this conference room location details. At step 480, the users' online calendars are updated with the conference room location (490) appearing on user devices 400. Processing thereafter ends at 495.

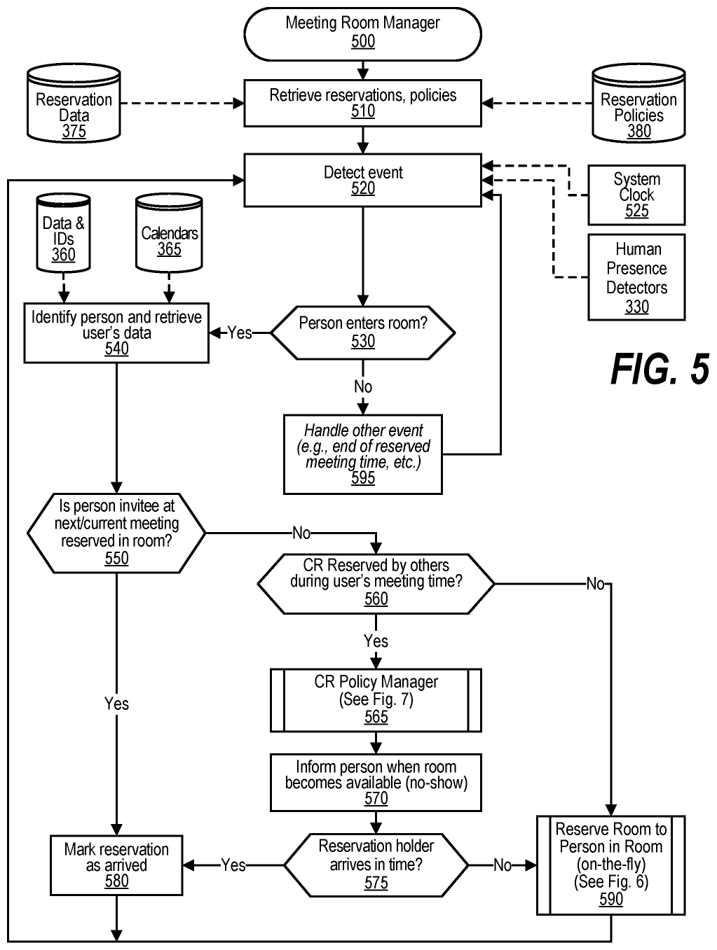

FIG. 5 depicts steps performed by a meeting room manager. processing loops back to detect the next event at 520. FIG. 5 processing commences at 500 and shows the steps taken by a meeting room manager process. At step 510, the process retrieves the current reservations and policies that pertain to the meeting room from data stores 375 and 380, respectively.

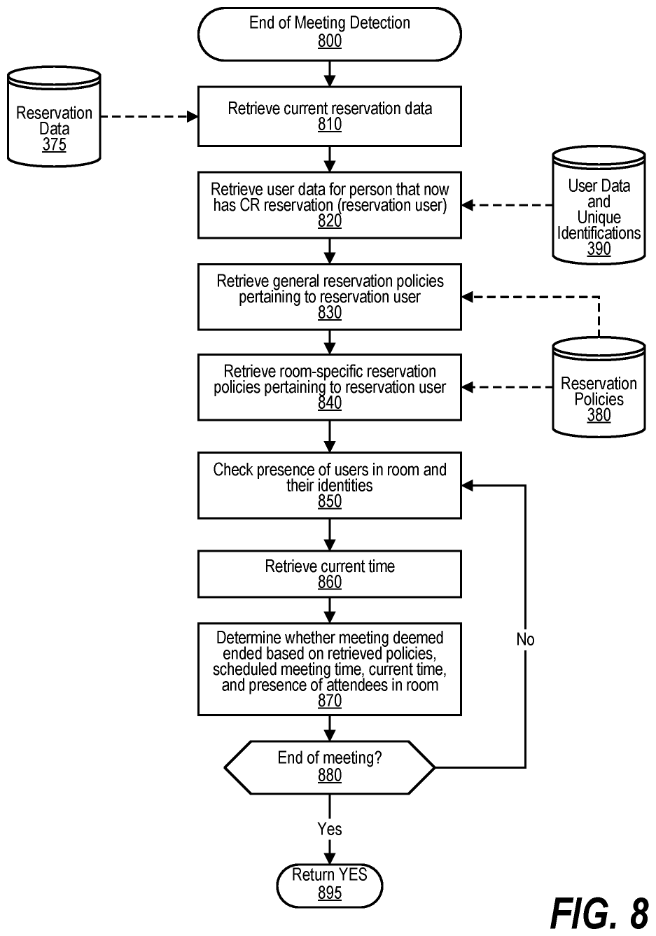

At step 520, the process detects an event that occurs in the meeting room utilizing human presence detectors 330 that are present in the meeting room as well as system clock 525 for time-based events. The process determines whether a person has entered the meeting room (decision 530). If a person has entered the meeting room, then decision 530 branches to the ‘yes’ branch to handle the new person event. On the other hand, if the event is not because a person has entered the room, then decision 530 branches to the ‘no’ branch whereupon, at step 595, some other event is processed by the meeting room manager and processing loops back to detect the next event at 520. One such other event is detection of when a current meeting taking place in the meeting room has ended. This detection is made by the process shown in FIG. 8.

Steps 540 through 590 are performed in response to the meeting room manager detecting a person entering the room. At step 540, the process identifies the person that entered the room and retrieves user data pertaining to the identified person. The person is identified using identification data retrieved from data store 360 and data, such as the person's online calendar, are retrieved from data store 365.

The process determines whether the person that entered the room is an invitee at the next or current meeting that has been reserved in the meeting room (decision 550). If the person is an invitee, then decision 550 branches to the ‘yes’ branch whereupon, at step 580, the reservation of the room is marked as ‘arrived’ confirming the room reservation. On the other hand, if the person is not an invitee, then decision 550 branches to the ‘no’ branch to perform steps 560 through 590 that might allow the person to reserve the meeting room ‘on-the-fly’ without previously reserving the room.

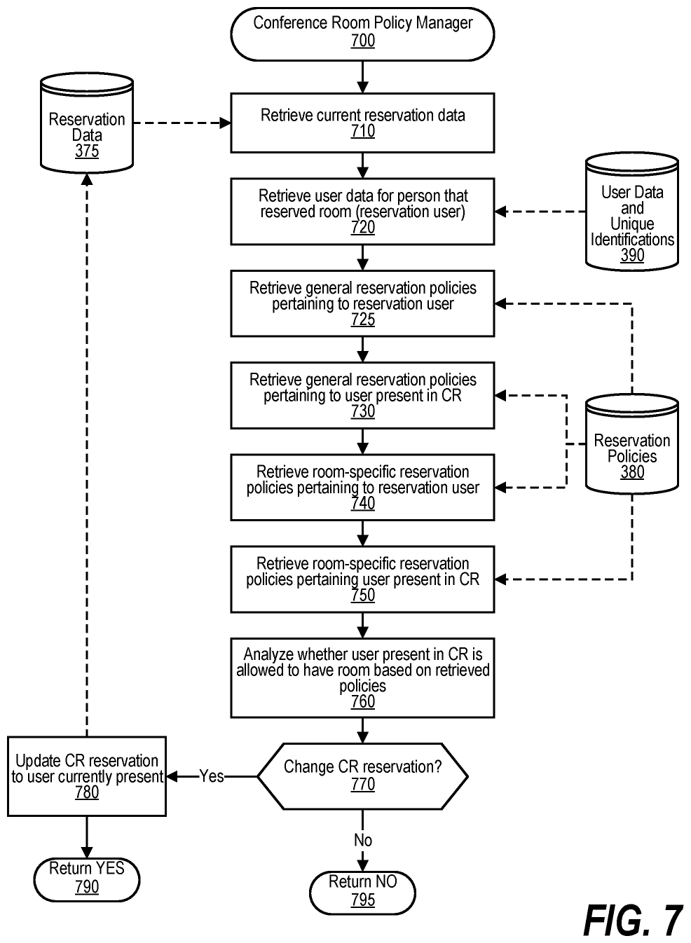

The process determines whether the meeting room is currently reserved by others (not including this user) during this user's meeting time (decision 560). If the meeting room is currently reserved by others, then decision 560 branches to the ‘yes’ branch whereupon, at predefined process 565, the room policy manager routine is called (see FIG. 7 and corresponding text for details). The policy manager determines when the room will be available based on any number of organizational and room factors, such as whether the reservation holder has enhanced status and can hold the room for an extended time, etc. In addition, at step 570, the user is informed when the room will become available if the current reservation holder fails to show up at the meeting room and waits to see if the reservation holder shows up in time.

On the other hand, if the meeting room is not reserved by others during this user's meeting time, then decision 560 branches to the ‘no’ branch whereupon, at predefined process 590, the process reserves the meeting room ‘on-the-fly’ for the user (person) that entered the meeting room in the detected event. Processing then loops back to step 520 to continue detecting and processing events that occur at the meeting room.

As previously mentioned, when the meeting room is reserved to others that have not yet arrived at the room, the user is informed when the room will become available if the others do not arrive at the meeting room (step 570) and then the process waits to see if the others that previously reserved the meeting room arrive in time. The process then determines whether the current reservation holder arrives in time (per policies received at 565) to claim the meeting room (decision 575).

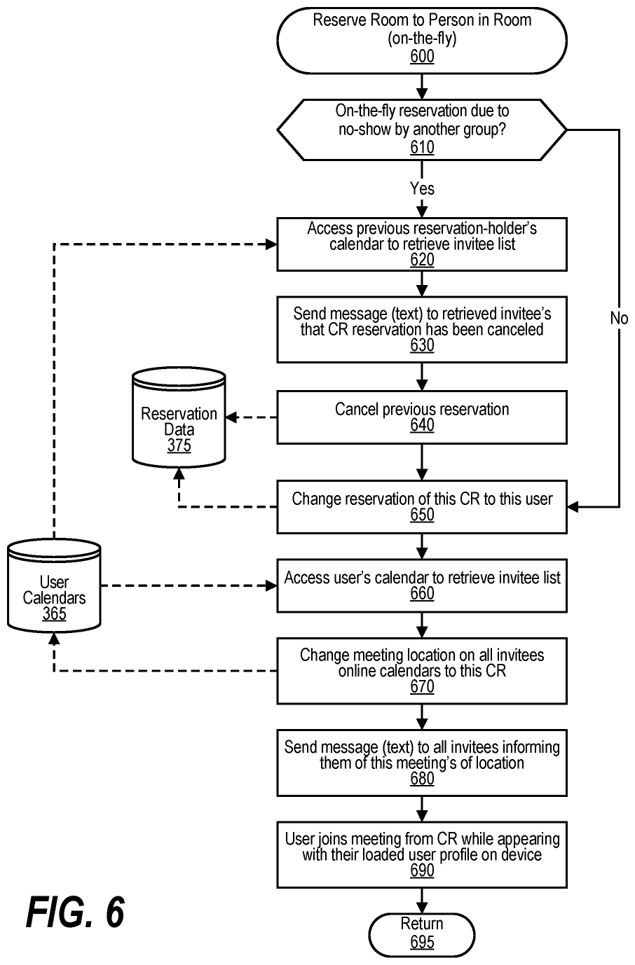

If the reservation holder arrives in time, then decision 575 branches to the ‘yes’ branch informing the user waiting on the room that the room is not available and, at step 580, the current reservation of the room is marked as ‘arrived’. On the other hand, if the reservation holder fails to arrive in time to claim the meeting room, then decision 575 branches to the ‘no’ branch whereupon, at predefined process 590, the process performs the Reserve Room to Person in Room (on-the-fly) routine (see FIG. 6 and corresponding text for processing details). Processing then loops back to step 520 to detect and process the next event that occurs at the meeting room as described above.

FIG. 6 depicts steps performed by a process that reserves a physical room to a user currently present in the room on-the-fly. FIG. 6 processing commences at 600 and shows the steps taken by a process that reserves a meeting room for a user in an ‘on-the-fly’ fashion when the user enters a meeting room that is able to be reserved to a walk-in user.

The process determines whether this on-the-fly reservation is due to a no-show by another group that previously reserved the meeting room (decision 610). If this on-the-fly reservation is due to a no-show by another group, then decision 610 branches to the ‘yes’ branch to perform steps 620 through 640 before continuing on with the remaining steps. On the other hand, if this on-the-fly reservation is not due to a no-show by another group, then decision 610 branches to the ‘no’ branch bypassing steps 620 through 640.

Steps 620 through 640 are performed when a no-show by a previous reservation holder occurs. At step 620, the process accesses the previous reservation-holder's calendar from data store 365 and retrieve the list of invitees. At step 630, the process sends messages (e.g., text message, emails, etc.) to the retrieved list of invitees that were scheduled to meet in this meeting room letting them know that the reservation has been canceled due to no one from the meeting showing up at the room in time to secure the room for their meeting. At step 640, the process cancels the previous reservation by marking the reservation as canceled in reservation data store 375.

Steps 650 through 695 are performed regardless of whether the room was previously reserved by another party. At step 650, the process changes the reservation of this meeting room to the user that showed up in the empty meeting room and requested an on-the-fly reservation. The reservation to this user is recorded in data store 375. At step 660, the process accesses the user's online calendar from data store 365 and retrieves the list of invitees to the meeting to which this user is also an invitee at the current date and time.

At step 670, the process changes the meeting location on all of the invitees' online calendars to this meeting room with these changes being recorded in data store 365. At step 680, the process sends messages (e.g., text messages, emails, etc.) to all of the invitees informing them that the meeting is being held in this meeting room. At step 690, the users join the meeting at the meeting room while appearing with their loaded user profile on their respective devices. Processing thereafter returns to the calling routine (see FIG. 5) at 695.

FIG. 7 depicts steps performed by a physical conference room policy manager process. FIG. 7 processing commences at 700 and shows the steps taken by a meeting room policy manager. At step 710, the process retrieves current reservation data from data store 375. At step 720, the process retrieves user data for the person that previously reserved the meeting room (the reservation user) from data store 390. At step 725, the process retrieves general reservation policies pertaining to the reservation user, such as whether the reservation user has enhanced status (e.g., the CEO, high level technical person, etc.). These policies are retrieved from data store 380.

At step 730, the process retrieves general reservation policies pertaining to the user that is currently present in the meeting room that wishes to reserve the room on-the-fly. These policies are retrieved from data store 380. At step 740, the process retrieves room-specific reservation policies pertaining to the reservation user, such as whether the user has enhanced status for this particular meeting room. These policies are also retrieved from data store 380. At step 750, the process retrieves room-specific reservation policies pertaining to the user that is currently present in the meeting room that wishes to reserve the room on-the-fly. These policies are retrieved from data store 380.

At step 760, based on the retrieved policies, the process analyzes whether the user that is currently present in the meeting room is allowed to have room based on retrieved policies with consideration being given for when the scheduled meeting by the reservation user was scheduled to begin. Based on the analysis, the process determines whether to change the reservation to the user that is currently in the meeting room (decision 770).

If the decision is to change the reservation, then decision 770 branches to the ‘yes’ branch whereupon, step 780, the process updates the reservation to the user currently present in the meeting room and at 790 processing returns to the calling routine (see FIG. 5) with a positive on-the-fly change indication.

On the other hand, if the decision is to not change the reservation at this time, then decision 770 branches to the ‘no’ branch and at 795 processing returns to the calling routine (see FIG. 5) with a negative on-the-fly change indication. This routine is repeatedly performed while the user requesting the room is waiting and the reservation holder has not appeared in the room so that, after more time has elapsed, the analysis and decision to change the reservation may change as per the policies stored in data store 380.

FIG. 8 depicts steps performed by a process that detects the end of a meeting taking place in a physical room. FIG. 8 processing commences at 800 and shows the steps taken by a process that detects when a meeting that was taking place in the meeting room has ended.

At step 810, the process retrieves current reservation data from data store 375. At step 820, the process retrieves user data for the person that now has the meeting room reservation, either a scheduled reservation holder or a person that reserved the room on-the-fly (this is the reservation user). At step 830, the process retrieves general reservation policies pertaining to the reservation user from data store 380. At step 840, the process retrieves any room-specific reservation policies pertaining to reservation user from data store 380.

At step 850, the process checks for the presence of users in room and their identities. The process also checks to see if the people present in the meeting room are also invitees to the present meeting. At step 860, the process retrieves current time. At step 870, the process determines whether the meeting is deemed to have ended based on the retrieved policies, the scheduled meeting time, the current time, and the presence of attendees in the meeting room.

The process determines whether the end of meeting has occurred (decision 880). If the meeting has ended, then decision 880 branches to the ‘yes’ branch and processing returns to the calling routine (see FIG. 5) with an indication that the meeting has ended. On the other hand, if the meeting has not ended, then decision 880 branches to the ‘no’ branch which continually loops back to step 850 to identify when the meeting has ended.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
detecting a presence of a user in a physical room;
identifying the detected user;
receiving an on-the-fly reservation request and determining that the physical room is available, the receiving including one or more reservation attributes and one or more invitees;
sending one or more messages to the invitees, wherein the messages include one or more physical room identifiers; and
joining, by the user, a meeting in the physical room with a set of meeting attributes including at least one of the physical room identifiers, wherein the meeting attributes are accessible from an information handling system utilized by the identified user.

2. The method of claim 1 further comprising:
identifying that the physical room is reserved by a first set of one or more users before detecting the presence of the user;
determining, based on a reservation policy, that the reservation by the first set of one or more user is cancelable; and
responsively canceling the reservation by the first set of one or more users to the physical room.

3. The method of claim 1 further comprising:
accessing an online calendar corresponding to the identified user;
retrieving a calendar entry corresponding to a current date and a current time; and
updating the retrieved calendar entry with at least one of the physical room identifiers.

4. The method of claim 1 further comprising:
identifying the user based on one or more sets of biometric data pertaining to the user, wherein the biometric data is received at one or more human presence detectors located in the physical room.

5. The method of claim 1 further comprising:
receiving the reservation request and the one or more reservation attributes spoken by the user at a microphone located in the physical room.

6. The method of claim 1 further comprising:
automatically accessing one or more online calendars corresponding to the invitees;
retrieving a calendar entry corresponding to a current date and a current time on each of the accessed online calendars; and
updating the retrieved calendar entry with at least one of the physical room identifiers.

7. The method of claim 1 further comprising:
determining that the physical room is available by checking one or more policies, wherein at least one of the policies is selected from the group consisting of an end of previous meeting detection, and a failure to show detection.

8. An information handling system comprising:
one or more processors;
a memory coupled to at least one of the processors;
a set of computer program instructions stored in the memory and executed by at least one of the processors in order to perform actions of:
detecting a presence of a user in a physical room;
identifying the detected user;
receiving an on-the-fly reservation request and determining that the physical room is available, the receiving including one or more reservation attributes and one or more invitees;
sending one or more messages to the invitees, wherein the messages include one or more physical room identifiers; and
joining, by the user, a meeting in the physical room with a set of meeting attributes including at least one of the physical room identifiers, wherein the meeting attributes are accessible from an information handling system utilized by the identified user.

9. The information handling system of claim 8 wherein the actions further comprise:
identifying that the physical room is reserved by a first set of one or more users before detecting the presence of the user;
determining, based on a reservation policy, that the reservation by the first set of one or more user is cancelable; and
responsively canceling the reservation by the first set of one or more users to the physical room.

10. The information handling system of claim 8 wherein the actions further comprise:
accessing an online calendar corresponding to the identified user;
retrieving a calendar entry corresponding to a current date and a current time; and
updating the retrieved calendar entry with at least one of the physical room identifiers.

11. The information handling system of claim 8 wherein the actions further comprise:
identifying the user based on one or more sets of biometric data pertaining to the user, wherein the biometric data is received at one or more human presence detectors located in the physical room.

12. The information handling system of claim 8 wherein the actions further comprise:
receiving the reservation request and the one or more reservation attributes spoken by the user at a microphone located in the physical room.

13. The information handling system of claim 8 wherein the actions further comprise:
automatically accessing one or more online calendars corresponding to the invitees;
retrieving a calendar entry corresponding to a current date and a current time on each of the accessed online calendars; and
updating the retrieved calendar entry with at least one of the physical room identifiers.

14. The information handling system of claim 8 wherein the actions further comprise:
determining that the physical room is available by checking one or more policies, wherein at least one of the policies is selected from the group consisting of an end of previous meeting detection, and a failure to show detection.

15. A computer program product stored in a computer readable storage medium, comprising computer program code that, when executed by an information handling system, causes the information handling system to perform actions comprising:
detecting a presence of a user in a physical room;
identifying the detected user;
receiving an on-the-fly reservation request and determining that the physical room is available, the receiving including one or more reservation attributes and one or more invitees;
sending one or more messages to the invitees, wherein the messages include one or more physical room identifiers; and
joining, by the user, a meeting in the physical room with a set of meeting attributes including at least one of the physical room identifiers, wherein the meeting attributes are accessible from an information handling system utilized by the identified user.

16. The computer program product of claim 15 wherein the actions further comprise:
identifying that the physical room is reserved by a first set of one or more users before detecting the presence of the user;
determining, based on a reservation policy, that the reservation by the first set of one or more user is cancelable; and
responsively canceling the reservation by the first set of one or more users to the physical room.

17. The computer program product of claim 15 wherein the actions further comprise:
accessing an online calendar corresponding to the identified user;
retrieving a calendar entry corresponding to a current date and a current time; and
updating the retrieved calendar entry with at least one of the physical room identifiers.

18. The computer program product of claim 15 wherein the actions further comprise:
identifying the user based on one or more sets of biometric data pertaining to the user, wherein the biometric data is received at one or more human presence detectors located in the physical room.

19. The computer program product of claim 15 wherein the actions further comprise:
receiving the reservation request and the one or more reservation attributes spoken by the user at a microphone located in the physical room.

20. The computer program product of claim 15 wherein the actions further comprise:
automatically accessing one or more online calendars corresponding to the invitees;
retrieving a calendar entry corresponding to a current date and a current time on each of the accessed online calendars; and
updating the retrieved calendar entry with at least one of the physical room identifiers.
